(19) United States
(12) Patent Application Publication
(10) Pub. No.: US 2026/0061577 A1
(43) Pub. Date: Mar. 5, 2026

(54) Labor-saving torque wrench

(71) Applicant: Hangzhou Rayman Tools Co., Ltd, Hangzhou (CN)

(72) Inventors: Jun SHAO, Hangzhou (CN); Liang HUA, Hangzhou (CN); Linwei XUE, Hangzhou (CN)

(73) Assignee: Hangzhou Rayman Tools Co., Ltd, Hangzhou (CN)

(21) Appl. No.: 18/906,395

(22) Filed: Oct. 4, 2024

(30) Foreign Application Priority Data
Aug. 28, 2024 (CN) 2024220978336

(51) Int. Cl. B25B 23/142; B25B 13/46

(52) U.S. Cl. CPC B25B 23/1427; B25B 13/46

(57) ABSTRACT

The present invention relates to a novel wrench, specifically, a labor-saving torque wrench, comprising a torque wrench body, wherein the torque wrench body comprises a ratchet wrench, a tube and a rotation bar, wherein the ratchet wrench is installed at an end of the tube, the rotation bar is installed at another end of the tube threadedly, a cavity for installing at least one torque spring is provided in the tube, a pressure pillar is slidably installed at an end of the tube away from the ratchet wrench, a torque adjusting wrench is fixed at an end portion of the rotation bar, a transmission steel ball is fixed at a center of an end of the torque adjusting bolt close to an end of the pressure pillar, and a positioning groove for snapping the transmission steel ball is provided at a surface of the pressure pillar, in the present invention, by designing the transmission steel ball and the pressure pillar to contact each other, the friction is small and it is less difficult to adjust the torque wrench.

### INCORPORATION BY REFERENCE

This application claims priority to China Patent Application No. 2024220978336, filed Aug. 28, 2024, the contents of which are hereby incorporated by reference in their entirety.

### TECHNICAL FIELD

The present invention relates to the technical field of a novel wrench, specifically, a labor-saving torque wrench.

### BACKGROUND TECHNOLOGY

Torque wrench is a kind of wrench, depending on where the power comes from, the torque wrenches are divided into power torque wrenches, pneumatic torque wrenches, hydraulic torque wrenches and manual torque wrenches, and by using a torque wrench, the operator can apply a specific torque.

During use, the force is changed by adjusting tightness of springs inside the torque wrench, rotating the handle of the torque wrench and by tightening and loosening the threads, so that the magnitude of the torque can be adjusted, during tightening and loosening, the surface of the bolt is adjusted to contact the pressure pillar, by rotating the handle to drive the torque adjusting bolt to push the pressure pillar to move forward, the pressure pillar makes axial movements via positioning of the positioning pin and pushes the spring.

With such torque wrench, although transmission and movement of the pressure pillar can be realized, it is difficult to make adjustment as planar friction in between the surface of the torque adjusting bolt and the pressure pillar is high.

### SUMMARY OF THE INVENTION

The purpose of the present invention is to provide a labor-saving torque wrench, in order to address the problem that with the torque wrenches currently available, although transmission and movement of the pressure pillar can be realized, a high friction is present in between the surface of the torque adjusting bolt and the pressure pillar and it is labor consuming to make adjustment.

To realize the foregoing purpose, the present invention provides a labor-saving torque wrench, comprising a torque wrench body, wherein the torque wrench body comprises a ratchet wrench, a tube and a rotation bar, wherein the ratchet wrench is installed at an end of the tube, the rotation bar is threadedly connected at another end of the tube, a cavity for installing at least one torque spring is provided in the tube, at least one pressure pillar is slidably connected at an end of the tube away from the ratchet wrench, a locking nut is fixed at an end portion of the rotation bar, a positioning bolt is threadedly connected on the locking nut, a washer is rotatably connected at an end of the positioning bolt in the rotation bar, a plurality of positioning pins are installed at a side of the washer orienting to the pressure pillar, a positioning toothed surface for abutting with and locking the plurality of positioning pins are provided at a surface of the pressure pillar, a torque adjusting bolt is fixed at an end portion of the rotation bar, at least one transmission steel ball is fixed at a center of an end of the torque adjusting bolt close to the pressure pillar, and a positioning groove for snapping the at least one transmission steel ball is provided on the surface of the pressure pillar.

As a further technical solution of the present invention, a rotation cap for allowing rotation is provided on an end portion of the positioning bolt.

As a further technical solution of the present invention, a circlip is provided at an end of the tube.

As a further technical solution of the present invention, a positioning shaft is provided at a side surface of the pressure pillar, and a positioning slot for allowing the positioning shaft to slide is provided on the side surface of the tube.

Compared with the prior art, in the present invention, by design the at least one transmission steel ball and the pressure pillar to contact each other, planar friction in the contact surface between the surface of the torque adjusting bolt and the pressure bolt is substituted, so that the friction is small and difficulty of adjusting is significantly reduced.

### BRIEF DESCRIPTION OF DRAWINGS

FIG. 1 is a structural diagram showing a labor-saving torque wrench according to the present invention.

FIG. 2 is an enlarged structural diagram of the labor-saving torque wrench according to the present invention.

In the drawings: 001 ratchet wrench; 002 tube; 003 rotation bar; 004 positioning pin; 005 torque adjusting bolt; 006 positioning shaft; 007 locking nut; 008 positioning bolt; 009 washer; 010 pressure pillar; 011 spring; 012 circlip; and 013 transmission steel ball.

### EMBODIMENTS

Hereinafter a detailed description will be further given to the technical solutions of the present invention.

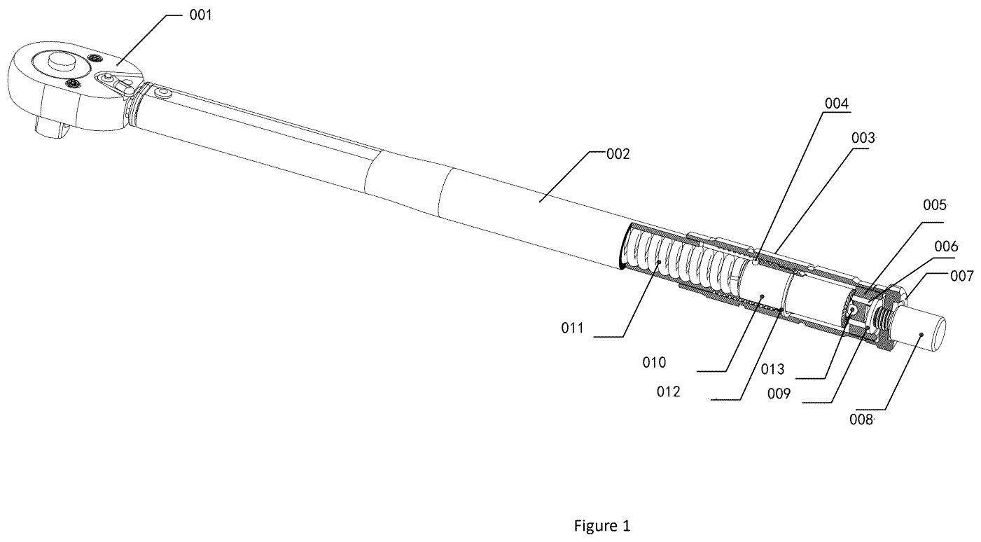

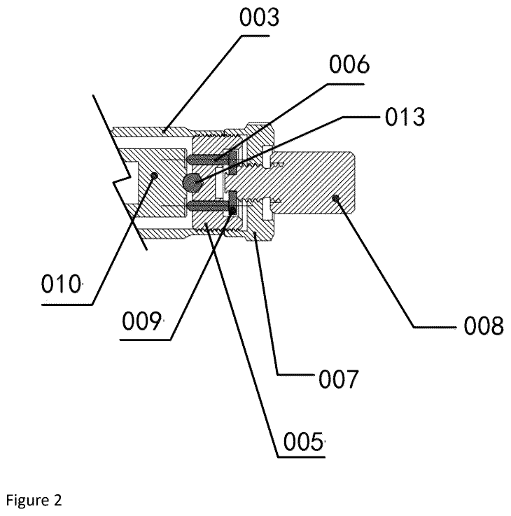

As shown in FIGS. 1 and 2, in an embodiment of the present invention, a labor-saving torque wrench, comprising a torque wrench body, the torque wrench body comprises a ratchet wrench 001, a tube 002 and a rotation bar 003, wherein the ratchet wrench 001 is installed at an end of the tube 002, the rotation bar 003 is rotatably connected at another end of the tube 002, a cavity for installed at least one torque spring 011 is provided in the tube 002, a pressure pillar 010 is slidably installed in the end of the tube 002 away from the ratchet wrench 001, a locking nut 007 is fixed at an end portion of the rotation bar 003, at least one positioning bolt 008 is threadedly installed on the locking nut 007, a washer 009 is rotatably connected at an end of the at least one positioning bolt 008 in the rotation bar 003, a plurality of positioning pins 006 are provided at a side of the washer 009 orienting to the pressure pillar 010, a positioning toothed surface for abutting with and locking the plurality of positioning pins 006 is provided on an end surface of the pressure pillar 010, a torque adjusting bolt 005 is provided at an end portion of the rotation bar 003, at least one transmission steel ball 013 is fixed in a center of the at least one torque adjusting bolt 005 close to the pressure pillar 010, and a positioning groove for snapping the at least one transmission steel ball 013 is provided on an end surface of the pressure pillar 010.

Specifically, the basic working principle of the present invention is:
1. The torque wrench can be rotated by the rotation bar 003 to change the torque by adjusting tightness of the springs and tightening or loosening the thread.
2. By rotating the at least one positioning bolt 008, the plurality of positioning pins 006 are released from the pressure pillar 010, at this time, release the rotation bar 003 and the pressure pillar 010, by rotating the rotation bar 003 to drive the at least one transmission ball 013 to push the pressure pillar 010 to drive the pressure pillar 010 to make axial linear movement, the at least one spring 011 is pushed.
3. After adjusting torque, by rotating the at least one positioning bolt 008, the plurality of positioning pins 006 and the pressure pillar 010 are pushed to position by the positioning toothed surface, and the rotation bar 003 and the pressure pillar 010 can be completely locked.

As shown in FIGS. 1 and 2, in an embodiment of the present invention, a rotation cap for allowing rotation is provided at an end portion of the at least one positioning bolt 008, for making it convenient to rotate the at least one positioning bolt 008.

As shown in FIGS. 1 and 2, in an embodiment of the present invention, a circlip 012 is provided at an end portion of the tube 002.

As shown in FIGS. 1 and 2, in an embodiment of the present invention, a positioning shaft 004 is provided at a side of the pressure pillar 010, a positioning slot for allowing the positioning shaft 004 to slide is provided at a side of the tube 002, during tightening and loosening the rotation bar 003, by rotating to push the pressure pillar 010 to move forward, the pressure pillar can be positioned via the positioning shaft 004 to make axial movement.

Above all, in the present invention, by designing the at least one transmission steel ball and the pressure pillar 010 to contact each other, planar friction in between the surface of the torque adjusting bolt 005 and the pressure pillar 010 is substituted, and the friction is thus reduced and the adjusting difficulty is significantly reduced.

The foregoing is a detailed description of the preferred embodiments of the present invention, however, the present invention is not limited to the foregoing embodiment, in the technical knowledge possessed by those of ordinary skill in the art, it is still feasible to make a plurality of variations without departing from the essence of the present invention.

1. A labor-saving torque wrench, comprising a torque wrench body, wherein the torque wrench body comprises a ratchet wrench, a tube and a rotation bar, the ratchet wrench is installed at an end of the tube, the rotation bar is rotatably and threadedly connected at another end of the tube, a cavity for installing at least one torque spring is provided in the tube, a pressure pillar is slidably installed in an end of the tube away from the ratchet wrench, a locking nut is provided at an end portion of the rotation bar, at least one positioning bolt is threadedly installed on the locking nut, a washer is rotatably connected with an end of the at least one positioning bolt in the rotation bar, a plurality of positioning pins are provided at a side of the washer orienting to the pressure pillar, a positioning toothed surface for abutting with and locking the plurality of positioning pins is provided on a surface of the pressure pillar, a torque adjusting bolt is provided at the end portion of the rotation bar, at least one transmission steel ball is fixed at a center of the torque adjusting bolt close to an end of the pressure pillar, and a positioning groove for fixing the at least one transmission steel ball is provided at an end surface of the pressure pillar.

2. The labor-saving torque wrench according to claim 1, wherein a rotation cap for allowing rotation is provided at an end portion of the at least one positioning bolt.

3. The labor-saving torque wrench according to claim 1, wherein a circlip is provided at an end portion of the tube.

4. The labor-saving torque wrench according to claim 1, wherein a positioning shaft is provided at a side of the pressure pillar and a positioning slot allowing the positioning shaft to slide is provided at a side of the tube.
